(19) United States
(12) Patent Application Publication
(10) Pub. No.: US 2014/0234515 A1
(43) Pub. Date: Aug. 21, 2014

(54) NUTRACEUTICAL FORMULATION

(71) Applicants: William Cain, Depew, NY (US); Sam Michael Milazzo, Cheektowaga, NY (US)

(72) Inventors: William Cain, Depew, NY (US); Sam Michael Milazzo, Cheektowaga, NY (US)

(21) Appl. No.: 14/169,444

(22) Filed: Jan. 31, 2014

Related U.S. Application Data
(60) Provisional application No. 61/765,069, filed on Feb. 15, 2013.
(60) Provisional application No. 61/885,596, filed on Oct. 2, 2013.

(51) Int. Cl. A23L 2/39

(52) U.S. Cl. CPC A23L 2/39
USPC 426/583; 426/593; 426/584

(57) ABSTRACT

This invention is directed to a nutraceutical formulation that provides a balance of 40% carbohydrates, 30% fat, and 30% protein. The nutraceutical formulation comprises egg protein, flax seed powder, coconut palm sugar, cocoa powder, raspberry extract, goji berry extract, sweet potato flour, wheat grass powder, and stevia extract. Optionally, MCT's (medium-chain triglycerides)may be included in the nutraceutical formulation.

### CROSS-REFERENCE TO RELATED APPLICATIONS

This application claims the benefit of, and incorporates by reference, U.S. Provisional Patent Application No. 61/765,069, filed Feb. 15, 2013, and U.S. Provisional Patent Application No. 61/885,596, filed Oct. 2, 2013.

### FIELD OF INVENTION

This invention is directed to a nutraceutical formulation that provides a balance of 40% carbohydrates, 30% fat, and 30% protein.

### BACKGROUND OF INVENTION

Often, individuals desiring to obtain a balanced but high protein diet have a difficult time finding suitable foods to meet their dietary goals. In particular, individuals that are training to build up a lot of muscle mass need to find suitable food sources to meet their protein needs. Body builders need protein right around the time of their workout. As a result, many body builders turn to protein shakes to ensure that they are reaching their protein intake requirements.

Recently, many dieters and weight-conscious individuals, including body builders, are attracted to a paleo diet. This diet is based upon the eating habits of our hunter-gatherer ancestors that lived during the Paleolithic era (also called the Stone Age). Under this diet, individuals eat fresh meats, fresh fruits, vegetables, seeds, nuts, and healthy oils such as olive, coconut, avocado, macadamia, walnut, and flaxseed. Excluded from this diet are dairy products, cereal grains, legumes, sugars, and anything processed.

Modern day living doesn't make it easy to follow a very strict paleo diet. This is because so many items at the grocery store are processed. Additionally, individuals often do not have enough time to prepare paleo meals. This is especially true for body builders that are about to go to the gym or have just finished at the gym. The protein intake needs to occur fairly quickly after a workout. Thus, body builders following a paleo diet need a quick way to consume protein while following the paleo diet.

To this point, body builders that are following the paleo diet cannot use protein shakes because the protein shakes thus far do not meet the strict standards of the paleo diet.

Thus, there is a need for a convenient protein shake that meets the strict standards of the paleo diet.

### SUMMARY OF THE INVENTION

Accordingly, it is the subject of this invention to provide a protein shake formulation that meets the strict standards of the paleo diet. In one of the preferred embodiments, a nutraceutical formulation is provided, including egg protein, coconut palm sugar, flax seed powder, raspberry extract, goji berry extract, wheat grass powder, cocoa powder, and sweet potato flour. In another preferred embodiment, a nutraceutical formulation includes egg protein in an amount of 37 wt %, coconut palm sugar in an amount of 27 wt %, flax seed powder in an amount of 19.5 wt %, raspberry extract in an amount of 3.8 wt %, goji berry extract in an amount of 3.8 wt %, wheat grass powder in an amount of at least 0.05 wt %, cocoa powder in an amount of 6.5 wt %, and sweet potato flour in an amount of 1.3 wt %.

In another preferred embodiment, a nutraceutical formulation is provided consisting essentially of egg protein in an amount of 37 wt %, coconut palm sugar in an amount of 27 wt %, flax seed powder in an amount of 19.5 wt %, raspberry extract in an amount of 3.8 wt %, goji berry extract in an amount of 3.8 wt %, wheat grass powder in an amount of at least 0.05 wt %, cocoa powder in an amount of 6.5 wt %, and sweet potato flour in an amount of 1.3 wt %.

### DETAILED DESCRIPTION OF THE INVENTION

In one embodiment, a nutraceutical formulation is provided, wherein the formulation comprises: egg protein, flax seed powder, coconut palm sugar, cocoa powder, raspberry extract, goji berry extract, sweet potato flour, wheat grass powder, and stevia extract. Optionally, MCI's (medium-chain triglycerides)may be included in the nutraceutical formulation.

In another embodiment, a nutraceutical formulation is provided, wherein the formulation comprises: egg white protein, cocoa powder, coconut sugar, guar gum, almond, flax seed powder, raspberries, goji berries, and optionally wheat grass powder.

In another embodiment, the nutraceutical formulation is in the form of a powder, which can be mixed with water or unsweetened almond milk (preferably Blue Diamond® a registered trademark of the Blue Diamond Growers Corporation) to create a protein shake. In this embodiment, about two tablespoons of the powder is mixed with 16 ounces of water or almond milk (or combinations thereof to provide a total of 16 ounces of liquid).

Preferably, the formulation has 313 calories of energy, 28 grams of protein, 35 grams of carbohydrates, and 7 grams of fat. When the formulation is mixed with almond milk, the formulation provides a balance of 40-30-30 nutrients, specifically 40% carbohydrates, 30% fat, and 30% protein. There are several commercial diets that require this ratio of nutrients for weight loss, including the Zone Diet® (a registered trademark of Barry D. Sears, Ph.D). Further, many nutritionists recommend this macronutrient breakdown as well.

In another embodiment, the formulation has 290 calories of energy, 28 grams of protein, 22 grams of carbohydrates, and 9 grams of fat. When the formulation is mixed with almond milk, the formulation provides a balance of 40-30-30 nutrients, specifically 40% fat, 30% carbohydrates, and 30% protein.

Research has indicated that 300-400 calories per meal is the maximum that the human body can absorb nutrients from at one time. Thus, for weight loss and weight maintenance, most dieticians and nutritionists advise eating 300-400 calories every three hours during the day.

While the above formulations are preferred embodiments, it is noted that some or all of the ingredients can be substituted. It is envisioned that quinoa protein may be substituted for the egg white protein, thereby allowing the formulation to be consumed by individuals that adhere to a vegan diet. Soy protein and whey protein and potato protein powder may also be used. Finally, hemp protein may be substituted for the protein source on its own or in combination with egg white protein to form an isolate blend. It is noted that any and all combinations of quinoa protein, soy protein, whey protein, potato protein powder, and hemp protein are suitable substitutes for the egg white protein

In another embodiment, other flavors are envisioned. Vanilla flavor may be substituted in place of or in addition to the cocoa powder, while blueberries may be substituted in place of or in addition to the raspberries.

The formulation disclosed herein provides several benefits. Coconut sugar is beneficial because it has a very low glycemic index, but provides good flavor. The same is true for cocoa powder, which has no sugar included and provides beneficial antioxidants.

Guar gum serves the two-fold purpose of stabilizing the formulation and providing natural fiber.

Almond flax seed powder and/or flax seed powder provides omega 3 amino acids along with fat and fatty acids.

Raspberries and goji berries are an additional source of antioxidants.

Finally, wheat grass powder provides healing benefits, along with chlorophyl, and antioxidants.

The above nutraceutical formulation can be supplied as a powder, which can then be mixed with water or unsweetened almond milk to produce an 8 ounce snack or a 16 ounce meal replacement. The formulation can also be supplied pre-mixed with water or unsweetened almond milk such that the formulation is ready to drink. In this case, a preservative may be required to preserve the formulation.

In another embodiment, the nutraceutical formulation is a powder and may be provided as part of a package, wherein the powder is supplied with a separate pre-sized container. The powder is placed in the container and the balance of the container is filled with water or unsweetened almond milk or another suitable liquid.

In another embodiment, the nutraceutical formulation is a powder and may be provided as part of a package, wherein the package has a divider pull tab such that the powder is on one side of the package and water and/or almond milk on the other side. The divider pull tab is easily pulled from the package so that the separated powder is introduced to the water and/or almond milk. The package can be shaken for adequate mixing of the power and water and/or almond milk.

One novel benefit of the nutraceutical formulation disclosed herein is that it is a protein supplement suitable for paleo dieters who also embrace strenuous workouts and therefore require protein supplementation. In particular, the ingredient choices provide protein supplementation while meeting the requirements of the paleo diet.

### EXAMPLES

### Example 1

A nutraceutical formulation is provided by simultaneously combining egg protein, flax seed powder, coconut palm sugar, cocoa powder, raspberry extract, goji berry extract, sweet potato flour, wheat grass powder, and stevia extract. The above ingredients are preferably organic grade meeting the organic standards of the USDA. Optionally, MCT's (medium-chain triglycerides) may be included in the nutraceutical formulation.

The total weight of the nutraceutical formulation is 77.0 g and has a caloric value of 321, whereby 64.3 calories are from fat. The nutraceutical formulation provides the following nutrients, total fat content of 7.15 grams or 11% of the recommended daily allowance (hereinafter “RDA”), saturated fat content of 0.96 grams or 5% of the RDA, 0% trans fat, 0% cholesterol, a sodium content of 359.86 mg or 15% of the RDA, total carbohydrate content of 33.1 grams or 11% of the RDA, a sugar content of 2.9 grams, a protein content of 28.13 g or 56% of the RDA. The nutraceutical formulation provides 0% of the RDA of Vitamin A and Vitamin C, 3.0 mg of calcium, providing 0% of the RDA, and 1.005 mg of iron, which is 13% of the RDA.

The nutraceutical formulation is in the form of a powder, which is then mixed with a liquid prior to consumption. Two tablespoons of the nutraceutical formulation powder are mixed with 12-16 oz of cold water or any suitable liquid, including, but not limited to, milk, almond milk, coconut milk, hemp milk, soy milk, rice milk, cashew milk, yogurt, or kefir. The preferred carbohydrate/fat/protein ratio of 40/30/30 per serving is obtained when two tablespoons of the powder are mixed with 16 oz of unsweetened almond milk.

### Example 2

A nutraceutical formulation is provided by simultaneously combining egg protein, coconut palm sugar, flax seed powder, raspberry extract, goji berry extract, wheat grass powder, cocoa powder, stevia extract, and sweet potato flour. The above ingredients are preferably organic grade meeting the organic standards of the USDA. Optionally, MCT's (medium-chain triglycerides) may be included in the nutraceutical formulation.

The nutraceutical formulation contains the ingredients in the following percentages (on a weight basis): 37% egg protein, 27% coconut palm sugar, 19.5% flax seed powder, 3.8% raspberry extract, 3.8% goji berry extract, 0.32% wheat grass powder, 6.5% cocoa powder, 0.13% stevia extract, and 1.3% sweet potato flour. The remaining less than 1% is made up of filler, such as moisture, minerals, ash, flavors, or other non-protein mass.

The nutraceutical formulation contains the ingredients in the following range of percentages (on a weight basis):

TABLE 1

| | | |
|---|---|---|
| Ingredient | Percentage | Range |

| | | | | |
|---|---|---|---|---|
| Egg Protein | 37.00 | wt % | 35.0-39.0 | wt % |
| Coconut Palm Sugar | 27.00 | wt % | 25.0-29.0 | wt % |
| Flax seed powder | 19.50 | wt % | 18.0-21.0 | wt % |
| Raspberry Extract | 3.80 | wt % | 3.3-4.3 | wt % |
| Goji Berry Extract | 3.80 | wt % | 3.3-4.3 | wt % |
| Wheat Grass Powder | 0.32 | wt % | 0.05-0.45 | wt % |
| Cocoa Powder | 6.50 | wt % | 5.5-7.5 | wt % |
| Stevia Extract | 0.13 | wt % | 0.08-0.18 | wt % |
| Sweet Potato Flour | 1.30 | wt % | 1.1-1.5 | wt % |

| | | |
|---|---|---|
| Filler | Balance | Balance |

The nutraceutical formulation is in the form of a powder, which is then mixed with a liquid prior to consumption. Two scoops of 77 grams each of the nutraceutical formulation powder are mixed with 12-16 oz of cold water or any suitable liquid, including, but not limited to, milk, almond milk, coconut milk, hemp milk, soy milk, rice milk, cashew milk, yogurt, or kefir. The preferred carbohydrate/fat/protein ratio of 40/30/30 per serving is obtained when two tablespoons of the powder are mixed with 16 oz of unsweetened almond milk.

It will be appreciated by those skilled in the art that while the nutraceutical formulation has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. A nutraceutical formulation comprising:
egg protein;
coconut palm sugar;
flax seed powder;
raspberry extract;
goji berry extract;
wheat grass powder;
cocoa powder; and
sweet potato flour.

2. The nutraceutical formulation of claim 1, wherein the amount of egg protein is from 35.0 and 39.0 wt %.

3. The nutraceutical formulation of claim 2, wherein the amount of coconut palm sugar is from 25.0 and 29.0 wt %.

4. The nutraceutical formulation of claim 3, wherein the amount of flax seed powder is from 18.0 and 21.0 wt %.

5. The nutraceutical formulation of claim 4, wherein the amount of raspberry extract is from 3.3 and 4.3 wt %.

6. The nutraceutical formulation of claim 5, wherein the amount of goji berry extract is from 3.3 and 4.3 wt %.

7. The nutraceutical formulation of claim 6, wherein the amount of wheat grass powder is from 0.05-0.45 wt %.

8. The nutraceutical formulation of claim 7, wherein the amount of cocoa powder is from 5.5-7.5 wt %.

9. The nutraceutical formulation of claim 8, wherein the amount of sweet potato flour is from 1.1 and 1.5 wt %.

10. The nutraceutical formulation of claim 9, wherein the formulation further comprises stevia extract in an amount from 0.08-0.18 wt %.

11. The nutraceutical formulation of claim 10, wherein the formulation further comprises 12-16 ounces of liquid selected from the group consisting of milk, almond milk, coconut milk, hemp milk, soy milk, rice milk, cashew milk, yogurt, or kefir.

12. The nutraceutical formulation of claim 11, wherein the carbohydrate/fat/protein ratio is 40/30/30.

13. A nutraceutical formulation comprising:
egg protein in an amount of 37 wt %;
coconut palm sugar in an amount of 27 wt %;
flax seed powder in an amount of 19.5 wt %;
raspberry extract in an amount of 3.8 wt %;
goji berry extract in an amount of 3.8 wt %;
wheat grass powder in an amount of at least 0.05 wt %;
cocoa powder in an amount of 6.5 wt %; and
sweet potato flour in an amount of 1.3 wt %.

14. The nutraceutical formulation of claim 13, wherein the formulation further comprises stevia extract in an amount of 0.13 wt %.

15. A nutraceutical formulation consisting essentially of:
egg protein in an amount of 37 wt %;
coconut palm sugar in an amount of 27 wt %;
flax seed powder in an amount of 19.5 wt %;
raspberry extract in an amount of 3.8 wt %;
goji berry extract in an amount of 3.8 wt %;
wheat grass powder in an amount of at least 0.05 wt %;
cocoa powder in an amount of 6.5 wt %; and
sweet potato flour in an amount of 1.3 wt %.

16. The nutraceutical formulation of claim 15, wherein the formulation further comprises stevia extract in an amount of 0.13 wt %.
